(19) United States
(12) Patent Application Publication
(10) Pub. No.: US 2007/0030432 A1
(43) Pub. Date: Feb. 8, 2007

(54) In plane switching liquid crystal display with storage capacitor corresponding to shielding metal line

(75) Inventors: Hung-Yu Chen, Miao-Li (TW); Tsau-Hua Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/501,610

(22) Filed: Aug. 8, 2006

(30) Foreign Application Priority Data
Aug. 8, 2005 (TW) 94126758

(51) Int. Cl. G02F 1/1343

(52) U.S. Cl. 349/141

(57) ABSTRACT

An exemplary in plane switching liquid crystal display (IPS LCD) includes a first substrate (230) and a second substrate (240) opposite to each other, a liquid crystal layer sandwiched between the first and second substrates. A shielding metal line (212) is arranged on the first substrate. A first insulation layer (222) is arranged on the shielding metal line. A drain line (203) is arranged on the first insulation layer and overlapping the shielding metal. A second insulation layer (223) is arranged on the drain line. A common electrode (210) is arranged on the second insulation layer and overlapping the drain line. A pixel electrode (211) is arranged on the second insulation layer and being parallel to the common electrode. The IPS LCD can obtain a high aperture ratio.

### FIELD OF THE INVENTION

The present invention relates to liquid crystal displays (LCDs), and particularly to an in plane switching (IPS) mode LCD having one or more storage capacitors corresponding to one or more shielding metal lines.

### BACKGROUND

An active matrix LCD generally includes a plurality of pixel regions defined by a plurality of gate lines and a plurality of data lines that cross each other. A plurality of thin film transistors (TFTs) is respectively arranged at intersections of the gate lines and the data lines. Each pixel region includes a pixel electrode, which is controlled by a corresponding TFT.

Rapid progress in the performance of active matrix LCDs has opened up a wide range of commercial and consumer applications, such as in flat television (TV) systems, and high-information content monitors for portable computers. A common type of technology used in the active matrix LCDs of these products is twisted nematic (TN) display mode technology. However, conventional TN display mode technology has intrinsic limitations including narrow viewing angle characteristics and slow response times. Most particularly, TN display mode technology has slow response times for gray scale operation.

In order to overcome these limitations, various techniques for use in active matrix LCDs have been developed. For example, an IPS (In Plane Switching) mode LCD has common and pixel electrodes formed on a same one of two substrates of the LCD. The electrodes control orientations of liquid crystal molecules in a liquid crystal layer of the LCD. In particular, the electrodes on the same substrate can produce an electrical field parallel to the substrate. Thus, the liquid crystal molecules can be aligned in a plane parallel to the substrate. In addition, to maintain a voltage of the pixel electrodes, a capacitor mechanism is employed between each common electrode and a corresponding pixel electrode. To obtain a predetermined capacitance, the pixel electrode and the common electrode must each have a certain minimum area. This means that an aperture ratio of the LCD may be compromised.

To obtain a higher aperture ratio, another type of IPS LCD has been developed. FIG. 3 shows a top view of certain components of one pixel region 100 of the IPS LCD, and FIG. 4 is a cross-sectional view of the pixel region 100 corresponding to line IV-IV of FIG. 3. The IPS LCD includes a first substrate 130, a second substrate 140, and a liquid crystal layer (not labeled) sandwiched between the first substrate 130 and the second substrate 140. The pixel region 100 is defined by two adjacent gate lines 101 and two adjacent data lines 102 crossing each other. The pixel region 100 includes a common electrode 109, a pixel electrode 108, shielding metal lines 104, and a thin film transistor (TFT) 106. The TFT 106 is arranged at an intersection of one of the gate lines 101 and one of the data lines 102. The shielding metal lines 104 are arranged at two opposite sides of each of the data lines 102, in order to avoid light leakage at edges of the pixel region 100 near the data lines 102. A black matrix 141 is arranged on the second substrate 140, and generally faces and covers the shielding metal lines 104.

A common line 103 crosses a central portion of the pixel region 100. The common electrode 109 has a transverse portion overlapping a transverse portion of the pixel electrode 108, and a dielectric layer (not labeled) separates the portion of the common electrode 109 and the portion of the pixel electrode 108. Thereby, a capacitor C1 is defined by the portion of the common electrode 109, the intervening dielectric layer, and the portion of the pixel electrode 108. The common line 103 has a portion underlying the portion of the pixel electrode 108, and another dielectric layer (not labeled) separates the portion of the common line 103 and the portion of the pixel electrode 108. Thereby, another capacitor C2 is defined by the portion of the common line 103, the intervening dielectric layer, and the portion of the pixel electrode 108. The common line 103 and the common electrode 109 are electrically connected with each other through a pair of contact holes 125. Thus, the capacitor C1 and the capacitor C2 are located one above the other, and are electrically connected in parallel to form a storage capacitor. A capacitance of the storage capacitor is the sum of a capacitance of the capacitor C1 and a capacitance of the capacitor C2. Therefore, the IPS LCD including the pixel region 100 can provide a high capacitance while still providing a high aperture ratio.

In the above-described IPS LCD, the storage capacitor is formed at a display area of the pixel region 100. The storage capacitor includes the portion of the common electrode 109, the portion of the pixel electrode 108, and the common line 103, one or more of which is typically made of metal. Therefore light transmission is blocked at the storage capacitor. Therefore, an aperture ratio of the IPS LCD is liable to be reduced.

What is needed, therefore, is an IPS LCD which includes a storage capacitor that does not unduly compromise an aperture ratio of the IPS LCD.

### SUMMARY

A first exemplary in plane switching liquid crystal display includes a first substrate and a second substrate opposite to each other, and a liquid crystal layer sandwiched between the first and second substrates. A shielding metal line is arranged on the first substrate. A first insulation layer is arranged on the shielding metal. A drain line is arranged on the first insulation layer and overlapping the shielding metal. A second insulation layer is arranged on the drain line. A common electrode is arranged on the second insulation layer and overlapping the drain line. A pixel electrode is arranged on the second insulation layer and being parallel to the common electrode.

A second exemplary in plane switching liquid crystal display includes a first substrate and a second substrate opposite to each other, and a liquid crystal layer sandwiched between the first and second substrates. A plurality of data lines and gate lines are formed at the first substrate and crossing each other, thereby defining a plurality of pixel regions. Each of the pixel regions comprises a shielding metal line arranged on the first substrate, a common electrode and a pixel electrode arranged in parallel and on the first substrate, and a storage capacitor facing the shielding metal line.

In the first in-plane switching liquid crystal display, the common electrode and the drain line both overlap the shielding metal line, a location of the storage capacitor defined by he drain line, the second insulation layer, and the common electrode corresponds to the location of the shielding metal line. Areas of the pixel region corresponding to the shielding metal line do not transmit light. That is, the storage capacitor is arranged at least partially and preferably substantially within areas of the pixel region that do not transmit light. Thus, compared with the pixel region of the above-described conventional IPS LCD, the storage capacitor occupies a smaller display area of the pixel region. In other words, the first IPS LCD can obtain a higher aperture ratio.

In the second in-plane switching liquid crystal display, the storage capacitor faces the shielding metal line. Areas of the pixel region corresponding to the shielding metal line do not transmit light. That is, the storage capacitor is arranged at least partially and preferably substantially within areas of the pixel region that do not transmit light. Thus, compared with the pixel region of the above-described conventional IPS LCD, the storage capacitor occupies a smaller display area of the pixel region. In other words, the second IPS LCD can obtain a higher aperture ratio.

Other advantages and novel features will become more apparent from the following detailed description when taken in conjunction with the accompanying drawings. In the drawings, all the views are schematic.

### BRIEF DESCRIPTION OF THE DRAWINGS

FIG. 1 is a top plan view of certain components of a pixel region of an IPS LCD according to a first preferred embodiment of the present invention.

FIG. 2 is a side cross-sectional view of part of a pixel region of the IPS LCD according to the first preferred embodiment, corresponding to line II-II of FIG. 1.

FIG. 3 is a top plan view of certain components of a pixel region of a conventional IPS LCD.

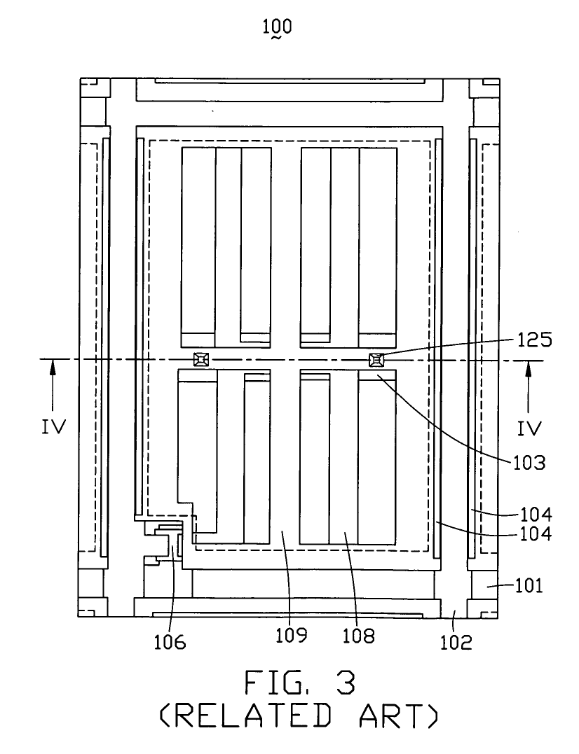

FIG. 4 is a side cross-sectional view of part of a pixel region of the conventional IPS LCD, corresponding to line IV-IV of FIG. 3.

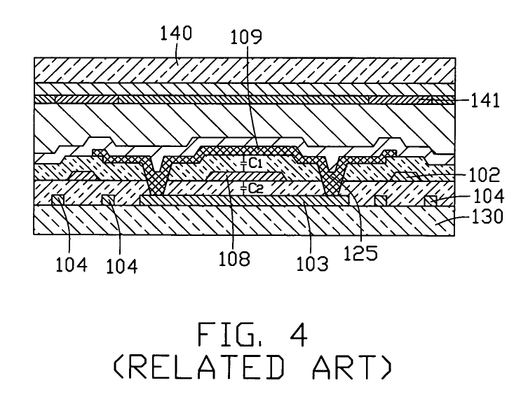

### DETAILED DESCRIPTION OF PREFERRED EMBODIMENTS

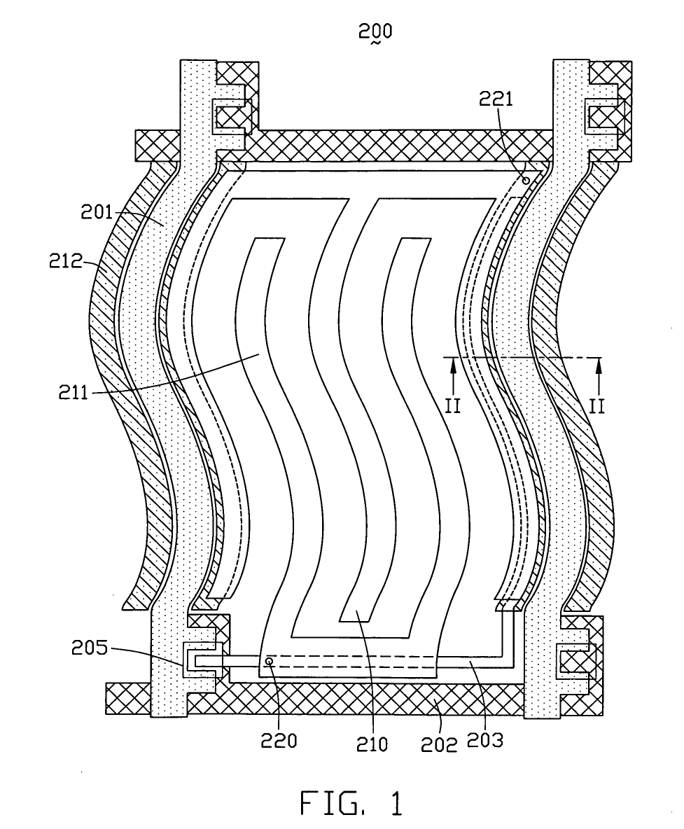

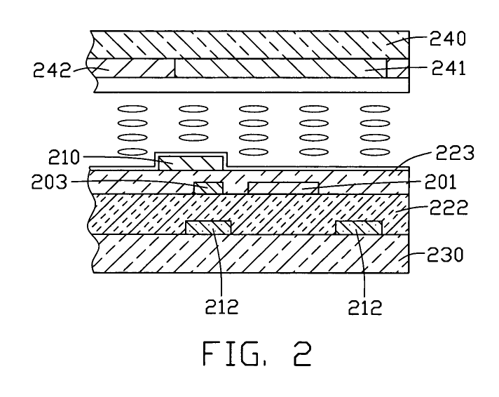

FIG. 1 shows a top view of certain components of one pixel region 200 of an IPS LCD of a first preferred embodiment of the present invention, and FIG. 2 is a cross-sectional view of the pixel region 200 corresponding to line II-II of FIG. 1. The IPS LCD includes a first substrate 230, a second substrate 240, and a liquid crystal layer (not labeled) sandwiched between the first substrate 230 and the second substrate 240. The pixel region 200 is defined by two adjacent gate lines 202 and two adjacent data lines 201 crossing each other. The pixel region 200 includes a common electrode 210, a pixel electrode 211, shielding metal lines 212, and a thin film transistor (TFT) 205. The TFT 205 is arranged at an intersection of one of the gate lines 202 and one of the data lines 201. The shielding metal lines 212 are arranged at two opposite sides of each of the data lines 201, in order to avoid light leakage at edges of the pixel region 200 near the data lines 201. The common electrode 210, the pixel electrode 211, and the data lines 201 are arranged parallel to each other. The common electrode 210, the pixel electrode 211, and the data lines 201 are curved.

Referring to FIG. 2, the shielding metal lines 212 are arranged on the first substrate 230, and a first insulation layer 222 is arranged on the shielding metal lines 212 and the first substrate 230. The data lines 201 are arranged on the first insulation layer 222. A drain line 203 electrically connects with the pixel electrode 211 through a contact hole 220 (see FIG. 1), which is arranged in the first insulation layer 222. The drain line 203 overlaps one of the shielding metal lines 212. A second insulation layer 223 is arranged on the first insulation layer 222 so that the second insulation layer 223 surrounds and covers the drain line 203 and the data line 201. The common electrode 210 is arranged on the second insulation layer 223, and the common electrode 210 has a portion that completely overlaps the drain line 203. A major portion of one of the shielding metal lines 212 is overlapped by the drain line 203. A black matrix 241 and a color filter layer 242 are cooperatively arranged on an underside of the second substrate 240. The black matrix 241 generally faces and covers the shielding metal lines 212. Further, a contact hole 221 (see FIG. 1) passes through the first insulation layer 222 and the second insulation layer 223. The common electrode 210 electrically connects with a corresponding one of the shielding metal lines 212 via the contact hole 221.

According to the above description, the common electrode 210, the drain line 203, and an intervening portion of the second insulation layer 223 cooperatively define a first capacitor. The drain line 203, said corresponding shielding metal line 212, and an intervening portion of the first insulation layer 222 define a second capacitor. Furthermore, the first capacitor and the second capacitor are electrically connected in parallel to form a storage capacitor. A capacitance of the storage capacitor is the sum of a capacitance of the first capacitor and a capacitance of the second capacitor. Because the common electrode 210 and the drain line 203 both overlap said corresponding shielding metal line 212, a location of the storage capacitor defined by the first capacitor and the second capacitor corresponds to the location of said corresponding shielding metal line 212. Areas of the pixel region 200 corresponding to the shielding metal lines 212 do not transmit light. That is, the storage capacitor is arranged at least partially and preferably substantially within areas of the pixel region 200 that do not transmit light. Thus, compared with the pixel region 100 of the above-described conventional IPS LCD, the storage capacitor occupies a smaller display area of the pixel region 200. In other words, the IPS LCD of the first preferred embodiment can obtain a higher aperture ratio.

In a second preferred embodiment, the contact hole 221 is omitted. Therefore the common electrode 210 does not electrically connect with said corresponding shielding metal line 212, and no voltage is applied to the shielding metal line 212. Accordingly, the storage capacitor is simply the same as the first capacitor, being formed by the common electrode 210, the intervening portion of the second insulation layer 223, and the drain line 203.

In the second preferred embodiment, because the common electrode 210 and the drain line 203 both overlap said corresponding shielding metal line 212, a location of the storage capacitor defined by the first capacitor corresponds to the location of said corresponding shielding metal line 212. Areas of the pixel region 200 corresponding to the shielding metal lines 212 do not transmit light. That is, the storage capacitor is arranged at least partially and preferably substantially within areas of the pixel region 200 that do not transmit light. Thus, compared with the pixel region 100 of the above-described conventional IPS LCD, the storage capacitor occupies a smaller display area of the pixel region 200. In other words, the IPS LCD of the second preferred embodiment can obtain a higher aperture ratio.

It is to be further understood that even though numerous characteristics and advantages of various embodiments have been set forth in the foregoing description, together with details of the structures and functions of the embodiments, the disclosure is illustrative only, and changes may be made in detail to the full extent indicated by the broad general meaning of the terms in which the appended claims are expressed.

What is claimed is:

1. An in plane switching liquid crystal display, comprising:
a first substrate and a second substrate opposite to each other;
a liquid crystal layer sandwiched between the first and second substrates;
a shielding metal line arranged on the first substrate,
a first insulation layer arranged on the shielding metal line;
a drain line arranged on the first insulation layer and overlapping the shielding metal line;
a second insulation layer arranged on the drain line;
a common electrode arranged on the second insulation layer and overlapping the drain line; and
a pixel electrode arranged on the second insulation layer and being parallel to the common electrode.

2. The in plane switching liquid crystal display as recited in claim 1, wherein

3. The in plane switching liquid crystal display as recited in claim 1, wherein a contact hole passes through the first and second insulation layers, and the shielding metal line is electrically connected with the common electrode through the contact hole.

4. The in plane switching liquid crystal display as recited in claim 1, wherein the common electrode has a curved structure.

5. The in plane switching liquid crystal display as recited in claim 4, further comprising a black matrix unit provided at the second substrate, the black matrix unit having a curved structure corresponding to the curved structure of the common electrode.

6. The in plane switching liquid crystal display as recited in claim 5, wherein the black matrix unit overlaps the shielding metal line.

7. The in plane switching liquid crystal display as recited in claim 1, wherein the second insulation layer is arranged to surround the drain line on all sides except a side at which the drain line abuts the first insulation layer.

8. An in plane switching liquid crystal display, comprising:
a first substrate and a second substrate opposite to each other;
a liquid crystal layer sandwiched between the first and second substrates; and
a plurality of data lines and gate lines formed at the first substrate and crossing each other, thereby defining a plurality of pixel regions;
wherein each of the pixel regions comprises a shielding metal line arranged on the first substrate, a common electrode and a pixel electrode arranged parallel to each other at the first substrate, and a storage capacitor positionally corresponding to the shielding metal line.

9. The in plane switching liquid crystal display as recited in claim 8, wherein each of the pixel regions further comprises a first insulation layer arranged on the shielding metal line, a drain line arranged on the first insulation layer, and a second insulation layer arranged on the drain line.

10. The in plane switching liquid crystal display as recited in claim 9, wherein the drain line overlaps the shielding metal line, the common electrode is arranged on the second insulation layer and overlaps the drain line, and the storage capacitor is formed by the drain line, the second insulation layer, and the common electrode.

11. The in plane switching liquid crystal display as recited in claim 9, wherein a contact hole passes through the first and second insulation layers, and the shielding metal line is electrically connected with the common electrode through the contact hole.

12. The in plane switching liquid crystal display as recited in claim 11, wherein the common electrode, the second insulation layer, and the drain line form a first capacitor, the drain line, the first insulation layer and the shielding metal line form a second capacitor, and the first capacitor and the second capacitor form the storage capacitor.

13. The in plane switching liquid crystal display as recited in claim 8, wherein the common electrode has a curved structure.

14. The in plane switching liquid crystal display as recited in claim 14, wherein each of the pixel regions further comprises a black matrix unit provided at the second substrate, the black matrix unit having a curved structure corresponding to the curved structure of the common electrode.

15. The in plane switching liquid crystal display as recited in claim 15, wherein the black matrix unit overlaps to the shielding metal line.
